(19) United States
(12) Patent Application Publication
(10) Pub. No.: US 2024/0399966 A1
(43) Pub. Date: Dec. 5, 2024

(54) Multifunctional Attachment Assembly

(71) Applicant: Electronic Design Associates, LLC, Strum, WI (US)

(72) Inventor: Jim Engandala, Strum, WI (US)

(21) Appl. No.: 18/676,892

(22) Filed: May 29, 2024

Related U.S. Application Data
(60) Provisional application No. 63/469,827, filed on May 30, 2023.

(51) Int. Cl. B60R 9/00; A01B 59/06; B60R 11/00; B60R 11/06

(52) U.S. Cl. CPC B60R 9/00; B60R 11/06; A01B 59/06; B60R 2011/004

(57) ABSTRACT

Embodiments of the present disclosure may include a attachment assembly for attachment to an agricultural vehicle, such as a tractor, to transport agricultural implements, tools and at least one person, the attachment assembly including a frame including plurality of panels cooperating to define an open space having side walls, and a back. Embodiments may also include a base having a front bumper with a hitch that detachably couples the frame to the agricultural vehicle. In some embodiments, the base may be attached to the frame and defines a floor of the attachment assembly. Embodiments may also include a safety rail assembly detachably attached to a front end of the frame. Embodiments may also include a leveling drag mounted on a bottom side of the base.

### RELATED APPLICATIONS

This application claims the benefit under 35 U.S.C. § 119 (c) of U.S. Provisional Patent Application No. 63/469,827, filed on May 29, 2023, which is incorporated herein by reference.

### BACKGROUND OF THE INVENTION

Agricultural operations often necessitate the use of various equipment and tools to carry out diverse tasks. Traditionally, this has required farmers and agricultural workers to invest in multiple pieces of equipment, each designed for a specific function. This approach, while effective in addressing specific tasks, poses several challenges. First, the cost associated with purchasing, maintaining, and storing numerous specialized tools and equipment can be prohibitively high. Second, frequent switching between different equipment can be time-consuming and inefficient, leading to delays in completing agricultural projects.

There is a growing need for a versatile solution that can integrate multiple functionalities into a single apparatus, thereby reducing the financial burden and improving operational efficiency. This need is particularly pressing in the context of small to mid-sized agricultural operations where resource constraints are more pronounced.

The present invention addresses these challenges by providing a novel attachment assembly that easily attaches to a variety of agricultural vehicles, such as tractors, and Skid-Steers. This attachment assembly is designed to facilitate the easy transport of individuals, equipment, and tools, thereby enhancing the flexibility and utility of the agricultural vehicle to which it is attached. The attachment assembly combines the functionalities of multiple agricultural tools and equipment into one cohesive apparatus. This integration allows users to perform a wide range of tasks, including snow removal, landscaping, tree-cutting and trimming, as well as house and barn painting and repair, without the need for multiple specialized machines. By consolidating these capabilities into a single unit, the attachment assembly significantly reduces the need for multiple expensive equipment purchases.

Furthermore, the attachment assembly enhances the overall efficiency of agricultural operations by enabling quick transitions between different tasks. This adaptability not only saves time but also reduces the physical and logistical burden on the user, thereby improving productivity and operational effectiveness.

In summary, the attachment assembly presented herein fulfills an unmet need for a flexible, multifunctional piece of agricultural equipment. It provides an economical and efficient solution for tackling a diverse array of agricultural projects, offering substantial advantages over traditional, single-function equipment.

### SUMMARY OF THE INVENTION

Embodiments of the present disclosure may include a attachment assembly for attachment to an agricultural vehicle, such as a tractor or a Skid Steer, to transport agricultural implements, tools and at least one person, the attachment assembly including a frame including plurality of panels cooperating to define an open space having side walls, and a back. Embodiments may also include a base having a front bumper with a hitch that detachably couples the frame to the agricultural vehicle. In some embodiments, the base may be attached to the frame and defines a floor of the attachment assembly. Embodiments may also include a safety rail assembly detachably attached to a front end of the frame. Embodiments may also include a landscaping leveling drag mounted on a bottom side of the base.

In some embodiments, the attachment assembly may include a tool box mounted to the back of the frame. In some embodiments, the tool box includes a plurality of side walls that define an opening for housing agricultural implements. In some embodiments, the frame further includes a plurality of handles integrated into a top end of the frame.

In some embodiments, the attachment assembly, having a tool rack mounted to the back of the frame between the side walls. In some embodiments, the tool rack has a plurality of slots configured to store a plurality of agricultural accessories. In some embodiments, the base further includes a plurality of wheels detachably attached to the base though at least one wheel tube. In some embodiment, the attachment assembly, further includes four tool tubes mounted to the frame near a corne for holding long handle tools such as shovels and rakes.

In some embodiments, the base supports the agricultural implements, tools, and at least one person. In some embodiments, the safety rail assembly includes a safety railing door latched to the frame and configured to open to about 180 degrees. In some embodiments, the safety harness secures the agricultural implements, the tools, and the at least one person to the within the attachment assembly.

In some embodiments, the leveling drag may be a diamond shaped landscaping blade. In some embodiments, the leveling drag has at least one removable side panel to prevent dirt or gravel from exiting from the drag. In some embodiments, the attachment assembly, the attachment assembly may include a lift assembly having a plurality of brackets mounted to the frame. In some embodiments, the hitch may be an integrated 3-way hitch.

Embodiments of the present disclosure may also include a method of transporting agricultural implements using an attachment assembly, the method including the steps providing an attachment assembly including. Embodiments may also include a frame including plurality of panels cooperating to define an open space having side walls, and a back.

In some embodiments, the frame includes a tool rack. Embodiments may also include a base having a front bumper with a hitch that detachably couples the frame to the agricultural vehicle. In some embodiments, the base may be attached to the frame and defines a floor of the attachment assembly. Embodiments may also include a safety rail assembly detachably attached to a front end of the frame.

Embodiments may also include attaching the hitch of the attachment assembly to an agricultural vehicle. Embodiments may also include placing agricultural implements on the base of the attachment assembly. Embodiments may also include securing the agricultural implements to the frame of the attachment assembly. Embodiments may also include transporting the agricultural implements from one location to another.

### BRIEF DESCRIPTION OF THE FIGURES

FIG. 1 illustrates a perspective view of a first embodiment of a multifunctional attachment assembly.

FIG. 2 illustrates a front view of the attachment assembly of FIG. 2.

FIG. 3 illustrates a back view of the attachment assembly of FIG. 1.

FIG. 4 illustrates a first side view of the attachment assembly of FIG. 1.

FIG. 5 illustrates a second side view of the attachment assembly of FIG. 1.

FIG. 6 illustrates a top view of the attachment assembly of FIG. 1.

FIG. 7 illustrates a bottom view of the attachment assembly of FIG. 1

FIG. 8 illustrates a front view of a second embodiment of the multifunctional attachment assembly.

FIG. 9 illustrates a back view of the attachment assembly of FIG. 8.

FIG. 10 illustrates a top view of the attachment assembly of FIG. 8.

FIG. 11 illustrates a bottom view of the attachment assembly of FIG. 8.

FIG. 12 illustrates a side view of the attachment assembly of FIG. 8.

### DETAILED DESCRIPTION

The present disclosure relates to a multifunctional attachment assembly 100. The attachment assembly 100 easily attaches to an agricultural vehicle, including but not limited to a tractor, or a Skid-Steer. The attachment assembly 100 advantageously allows for easy transport of a plurality of individuals, agricultural equipment and tools. The attachment assembly 100 also combines the functionality of multiple agricultural equipment and tools into one apparatus. The attachment assembly 100 allows a user to tackle multiples different projects, ranging from snow removal to tree-cutting/trimming and house/barn painting and repair. To this end, the attachment assembly 100 fulfills multiple needs without having to purchase numerous pieces of expensive equipment. The attachment assembly 100 shown and described below, advantageously solves an unmet need for flexibility in one piece of agricultural equipment.

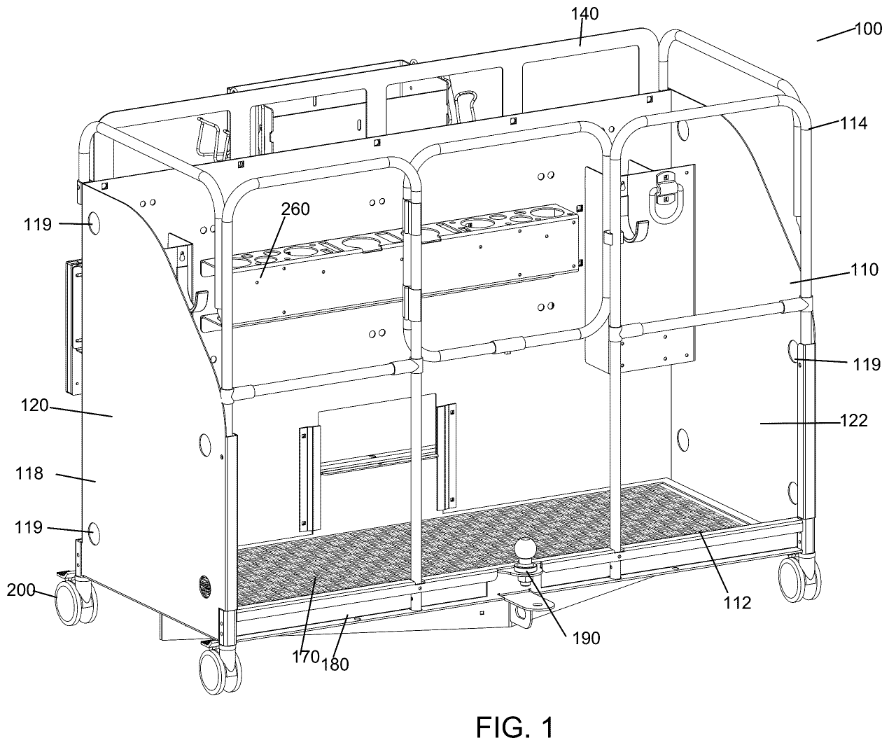

Referring to FIG. 1, the attachment assembly 100 may include a frame 110, a base 112, and a safety rail assembly 114 detachably attached to a front end of the frame 110. The frame 110 may include a plurality of panels 118 cooperating to define an open space. The plurality of panels 118 make up a first (left) side wall 120, a second (right) side wall 122, and a back wall 124. The frame 110's plurality of panels 118 further defines both an internal and external side 126, 128 of the frame 110 and the front end 116 and back end 132 of the frame 110, thereby creating an open space within the frame 110 to accommodate equipment, tools, and/or people.

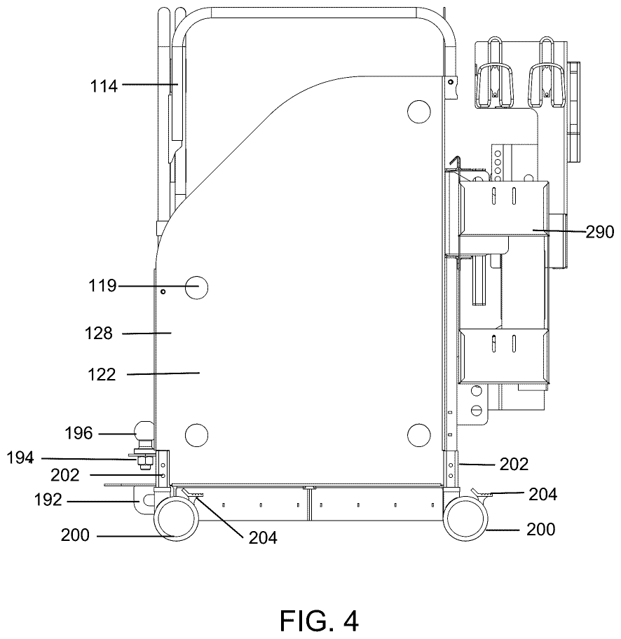

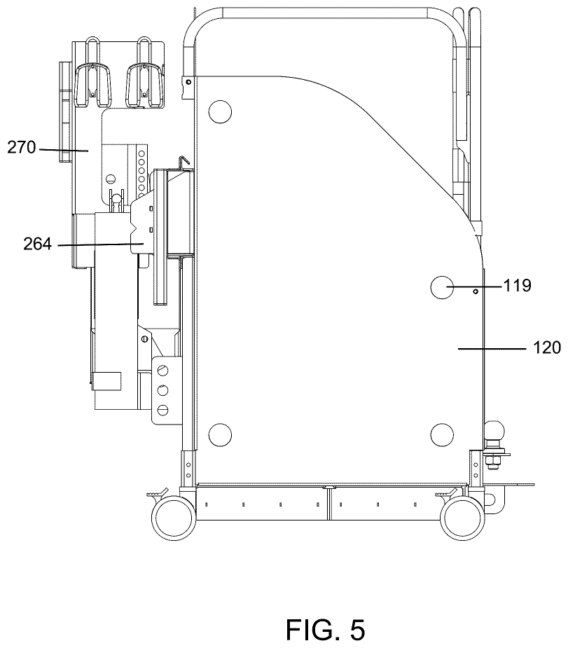

Referring to FIGS. 1-5, the frame 110 may be formed from a single sheet of metal that is bent to form the sides and the back. In other embodiments, the frame 110 is assembled from a plurality of panels 118 that are welded together to create the left side wall 120, the right side wall 122, and the back wall 124 of the frame 110. The forming or assembly of the frame 110 provides structural integrity which ensures the stability and load-bearing capacity necessary for the attachment assembly 100's functionality. During the manufacture of the frame 110, gear tie holes, and tie strap holes 119 are cut into the panels 118. Additionally, a plurality of pre-cut holes 134 in at least one of the plurality of panels 118 used to accommodate a means for attaching a plurality of accessories to the frame 110. The attachment means including but not limited to bolts, hooks, rings, brackets and ties.

The frame 110's material composition is selected for its strength and durability, capable of withstanding the weight of agricultural implements or multiple occupants while maintaining stability during transportation or lifting operations. The frame material must be stable enough to allow the frame 110 to be lifted in the air and to accommodate numerous attachments that may be added to the frame 110 during assembly of the attachment assembly 100.

In some embodiments, the frame 110 is made of steel, specifically 12 gauge steel. In other embodiments, the frame 110's construction may incorporate materials other than steel, such as aluminum or composite materials, offering advantages such as reduced weight or corrosion resistance while maintaining structural integrity. Furthermore, the frame 110's design may feature alternative joining techniques, including riveting, bolting, or adhesive bonding, providing flexibility in manufacturing processes and potentially enhancing assembly efficiency. Additionally, the frame 110's geometry and dimensions may be modified to accommodate specific application requirements, such as increased payload capacity, dimensional constraints, or ergonomic considerations.

Referring again to FIG. 1, the frame 110 further includes a grab handle 140 positioned atop the back panel of the frame 110. The grab handle 140 includes at least one handle, or in some embodiments a plurality of handles. In some embodiments, the grab handles include 4 integrated handles that span the entire top of the back panel. The grab handle 140 may be secured to the back panel using any securing method, including but not limited to welding, bolts, and screws. The grab handle 140 may also be made of any metal, for example steel. In some embodiments, the grab handle 140 is made from 5/16 gauge steel.

Each grab handle 140 may be include a rectangular shape with an open space 142 to accommodate a hand of a user. The open space 142 of the grab handles 140 also allows for attaching at least one safety harness 144. A strap 146 of the safety harness 144 is connected to the grab handles 140 for securing agricultural equipment, tools, or riders. Optionally, the grab handles 140 may include any ergonomic shape that accommodate the hand of the user and/or the straps 146 of the safety harness 144. In some embodiments, the safety harness 144

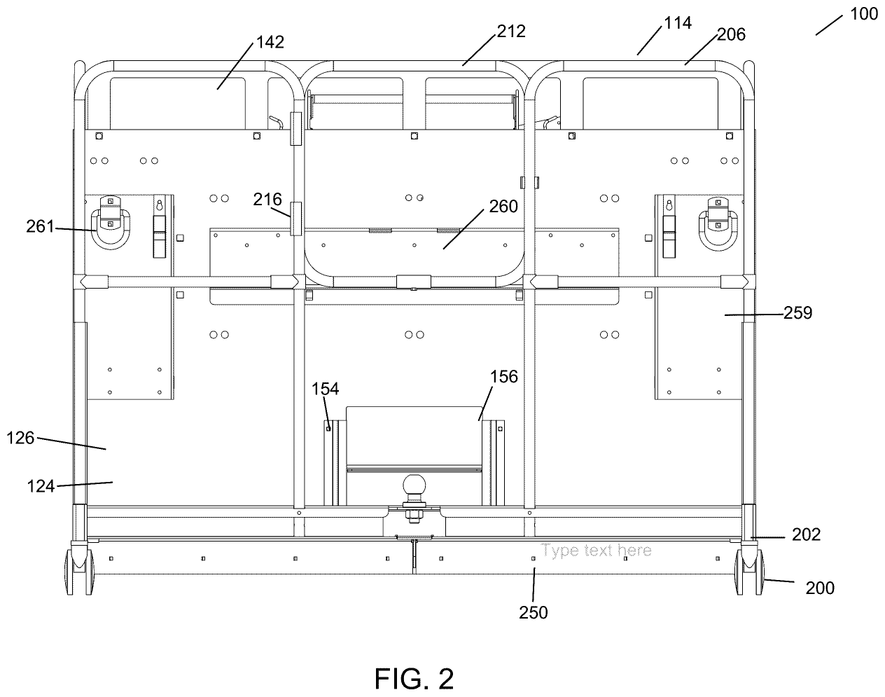

Referring to FIGS. 1 and 2, the frame 110 further includes an integrated drain door assembly 150 for efficient maintenance and cleanliness of the attachment assembly 100. Positioned near a bottom end 152 of the back wall 124, the drain door assembly 150 enables users to swiftly remove accumulated dirt, debris, and water from the base 112. The drain door assembly 150 comprises two primary components: the drain door rail 154 and the drain door 156. The drain door rail 154 is typically attached using bolted connections, such as carriage bolts with flange unlock lock nuts, is securely affixed to the back wall 124 of the frame 110, near the base 112. The drain door 156 is arranged on the drain door rail 154 to facilitate upward and downward movement relative to the frame 110, enabling seamless transition between an open and a closed configuration. When the drain door 156 is in the open configuration, the drain door 156 creates an opening 158 in the back wall 124 of the frame 110 allowing for the passage of debris and water, effectively draining them out of the attachment assembly 100.

The drain door assembly 150 can be crafted from any metal. The drain door assembly 150 may be made from the same material as the frame 110, promoting uniformity in structural properties and facilitating seamless integration within the attachment assembly 100. In certain embodiments, the drain door rail 152 is constructed from 10 gauge steel. This heavier gauge steel provides robust support and stability for the drain door assembly 150, ensuring smooth operation and longevity over time. Conversely, the drain door 156 itself may be fabricated from 12 gauge steel in some embodiments, offering a balance between strength and flexibility. This slightly lighter gauge steel facilitates the drain door 156's movement within the drain door rail 154 while maintaining sufficient rigidity to effectively seal the drain opening 158 when closed. Moreover, alternative embodiments may explore different material options for the drain door assembly 150 components, such as aluminum or composite materials, to address specific performance criteria or environmental considerations.

To ensure the longevity and durability of the attachment assembly 100, protective measures may be implemented to shield its metal components, particularly the frame 110, from corrosion and deterioration caused by exposure to various weather conditions. One such protective measure involves applying a rust-resistant coating, which forms a barrier against moisture and environmental contaminants. Various rust-resistant coating options may be considered, each chosen for its ability to withstand prolonged use and exposure, thereby prolonging the assembly's service life and reducing maintenance requirements. In some embodiments, the protective coating, is a rust resistant powder which is applied to the frame 110, and other metal components.

Furthermore, the rust-resistant coating extends beyond mere functionality, as it also contributes to the overall visual appearance of the attachment assembly 100. In some embodiments, the coating may be colored to impart a distinctive aesthetic characteristic, enhancing the assembly's visibility and complementing its intended application environment. Colors such as grey, orange, or green may be selected to align with branding preferences, safety standards, or aesthetic considerations. This deliberate choice of color not only serves practical purposes, such as improving visibility in agricultural settings or enhancing coordination with existing equipment, but also adds a layer of customization and personalization to the attachment assembly 100, reflecting the preferences and identity of its users.

Referring to FIGS. 1-6, the base 112 of the attachment assembly 100 plays a crucial role in providing stability, support, and mobility, thereby facilitating its versatile functionality across various applications. The support and structural integrity provided by the base 112 accommodates the weight and dynamic forces exerted by the payload within the frame 110. The plurality of panels 118 are attached to the base 112 to form a platform 160 on which the agricultural implements, tool and/or people are placed within the frame 110. The base 112 may be attached to the platform 160 using any conventional attachment method. In some embodiments the base 112 is welded to the frame 110 to bolster the structural integrity and load-carrying capacity of the attachment assembly 100.

Additionally, the base 112 may be made of any suitable material, for example 12 gauge steel. In some embodiments, the frame 110 and the base 112 made be made of the same material. In some embodiments, the base 112 and frame 110 may be constructed from the same material, providing uniformity in structural properties and simplifying manufacturing processes. In other embodiments different materials for the base 112 and frame 110 may be utilized to address specific performance needs, such as optimizing weight distribution, enhancing corrosion resistance, or reducing overall assembly mass. This versatility in material selection enables the attachment assembly 100 to adapt to a wide range of applications and operating conditions.

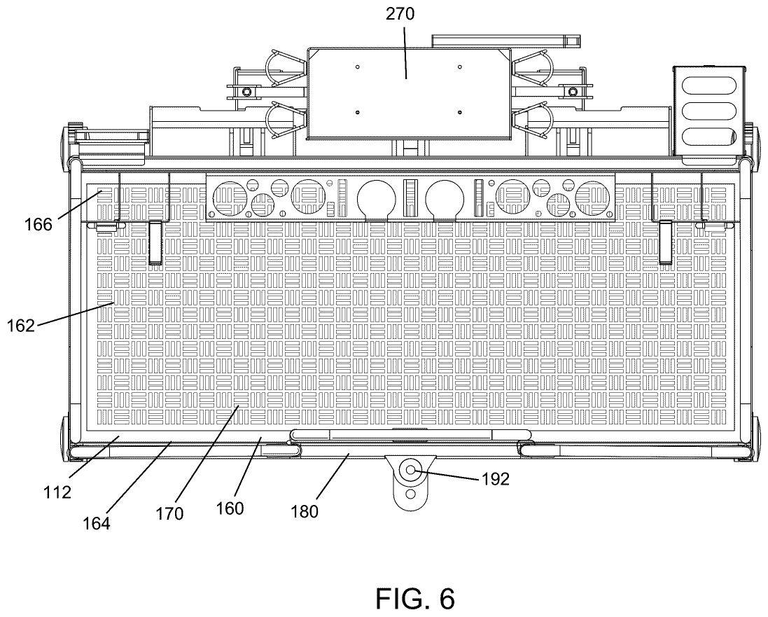

Referring FIG. 6, the base 112 defines a top side 162 and bottom side 163, a front end and a back end 164, 166. The plurality of panels 118, including the first (left) side wall 120 and second (right) side 122, and back wall 124 of the frame 110 are bonded to the top side 162 of the base 112. The base 112 further defines a length and a width that may be sized and shaped to correspond to the width and a depth of the frame 110 created by the plurality of panels 118. The base 112 may have a thickness that is sufficient to accommodate the load-carrying capacity of the attachment assembly 100, while balancing structural and strength considerations. Loading and unloading of the attachment assembly 100 may be facilitated through the front end 164 of the base 112. In some embodiments, manual loading onto the base 112 is facilitated by the user. In other embodiments, loading mechanisms, such as hydraulic ramps or automated lifting systems, may be utilized in a wide range of industrial and logistical applications.

Referring again to FIG. 6, the top side of the base 112 may also include a floor mat 170. The floor mat 170 may be sized and shaped to cover the entire top side 162 of the base 112. The floor mat 170 is non-slip and provides a secure footing surface, minimizing the risk of slippage or accidents during loading, unloading, and transportation activities. Furthermore, the floor mat 170 may be removed from the base 112, allowing thorough cleaning of both the floor mat 170 and the top side 162 of the base 112 to remove dirt, debris, and contaminants. The floor mat 170 may be constructed of any flexible, durable, and water-resistant material. In some embodiments, the floor mat 170 is made of rubber.

The base 112 may also include a front-end bumper 180 attached to the front end 164 of the base 112 with an integrated hitch assembly 190 that detachably couples to a hitch receiver on a rear of the agricultural vehicle. The front bumper 180 serves a dual purpose: providing impact protection for the attachment assembly 100 and enabling seamless coupling to the hitch receiver 182 located at the rear of the agricultural vehicle. The front bumper 180 is welded to the base 112. Optionally, in other embodiments, other methods of securing the front bumper 180 to the base 112 may be employed.

The hitch assembly 190 comprises several key components, including a hitch bracket 192, a hitch gusset 194, and a hitch flange 196. The hitch bracket 192 serves as a sturdy mounting structure, typically welded or bolted to the front-end bumper 180, providing a stable foundation for the hitch assembly 190. Attached to the hitch bracket 192 is the hitch gusset 194, which is reinforcing the connection and enhancing the overall structural integrity of the hitch assembly 190. Additionally, the hitch flange 196, positioned at a front of the hitch bracket 192, serves as the primary interface for coupling with the hitch receiver located on the rear 184 of the agricultural vehicle.

In various embodiments, the hitch assembly 190 may be chosen to accommodate different coupling configurations and attachment methods to suit specific vehicle requirements. For instance, the hitch flange 196 may be designed to conform to industry-standard hitch receiver 182 sizes, ensuring compatibility with a wide range of agricultural vehicles and towing equipment. Alternatively, the hitch assembly 190 may include a 3-point hitch configuration, featuring three attachment points arranged in a triangular formation. This versatile hitch design offers flexibility in coupling options, allowing operators to select the most suitable configuration for their specific towing needs while ensuring reliable and secure attachment between the attachment assembly 100 and the agricultural vehicle. The front-end bumper 180 and the hitch assembly 190 may be made of any suitable metal, specifically 7-gauge steel.

Referring to FIGS. 1-4, the base 112 further includes a plurality of wheels 200 detachably attached to the bottom end of the base 112 though a corresponding number of wheel tubes 202. In some embodiments, the base 112 is equipped with at least four wheels 200, each attached to a dedicated wheel tube 202. The wheel tubes 202 are affixed to the bottom end of the base 112, preferably through welding, to withstand the stresses and forces encountered during operation of the attachment assembly 100. In the assembly process, the wheels 200 are inserted into the wheel tubes 202, and they are secured through the use of snap pins. The wheels 200 may each includes a wheel stop 204 for locking and locking the wheels in order to restrict or allow movement of the attachment assembly 100.

Referring to again to FIG. 1, the safety rail assembly 114 is removably attached to the frame 110 through a plurality of snap pins 204, providing case of installation and removal as needed. The safety railing assembly 114 includes a safety railing 206 which defines a left side 208 and a right side 210, and a safety railing door 212. The left and right sides 208, 210 of the safety railing 206 feature cross braces 214 for added stability, reinforcing the structural integrity of the attachment assembly 100 during operation.

The safety railing door 212 is removably mounted to the safety railing 206 using a hinge assembly 216. The hinge assembly 216 for the safety railing door 212 may utilize a 1-inch eye-bolt hinge, with a wide range of motion of up to 180 degrees. In some embodiments, the safety railing assembly 114 is not removably attached to the frame 110. Instead, the safety railing 206 is bolted to the frame 110 and the safety railing door 212 is bolted to the safety railing 206. To ensure secure closure, a door latch mechanism 218 is incorporated, attached on one side to the safety railing door 212 using a safety railing door latch plate 220, and on the other side to the safety railing 206 using a safety railing latch plate 222. When the attachment assembly 100 is not int use, the entire safety rail assembly 114 can be detached from the frame 110 for easy storage.

In various embodiments, both the safety railing 206 and the safety railing door 212 are constructed from the same material, preferably zinc-electroplated magnetic tubing conduit with a diameter of about ¾ inch, offering corrosion resistance and structural strength. The door latch mechanism 218 is preferably made of 12 gauge steel.

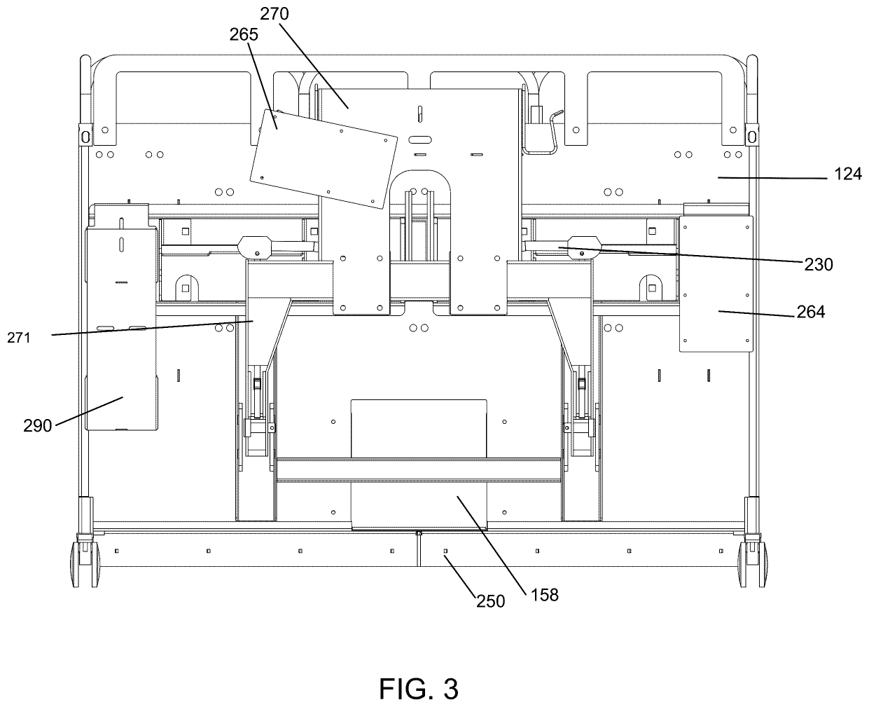

Referring to FIG. 3, the attachment assembly 100 further includes a lift assembly 230 configured to allow the attachment assembly 100 to be lifted by a vehicle such as a Skid Steer. The attachment assembly 100 includes an upper channel 232, a vertical channel 234, a lower channel 236, an upper 3-point bracket, and a lower 3-point bracket. The upper and lower 3-point brackets are mounted, preferably welded, to the upper channel 232, the vertical channel 234, and the lower channel 236 in an H-Pattern. The lift assembly 230 is then mounted, preferably welded, to the back wall 124 of the frame 110. This configuration provides a secure and stable connection between the upper and lower brackets, enabling the lift assembly 230 to withstand significant loads, including up to about 2000 lbs of dirt and gravel, and forces encountered during operation without deforming.

The lift assembly 230 may be constructed from any sufficiently strong metal. In various embodiments, the upper channel 232, vertical channel 234, and lower channel 236 are made of the same material, preferably 10 gauge steel. This material provides the necessary strength and resilience to support heavy loads and withstand the stresses encountered during lifting and maneuvering tasks.

In various embodiments, the upper and lower 3 point brackets 238, 240 are made of 5/16 gauge steel. This heavier gauge steel enhances the load-bearing capacity and reinforces critical attachment points, ensuring secure and stable connections between the lift assembly 230 components. The use of 5/16 gauge steel in these brackets enhances the lift assembly 230's ability to withstand significant forces and impacts, contributing to its overall robustness and reliability.

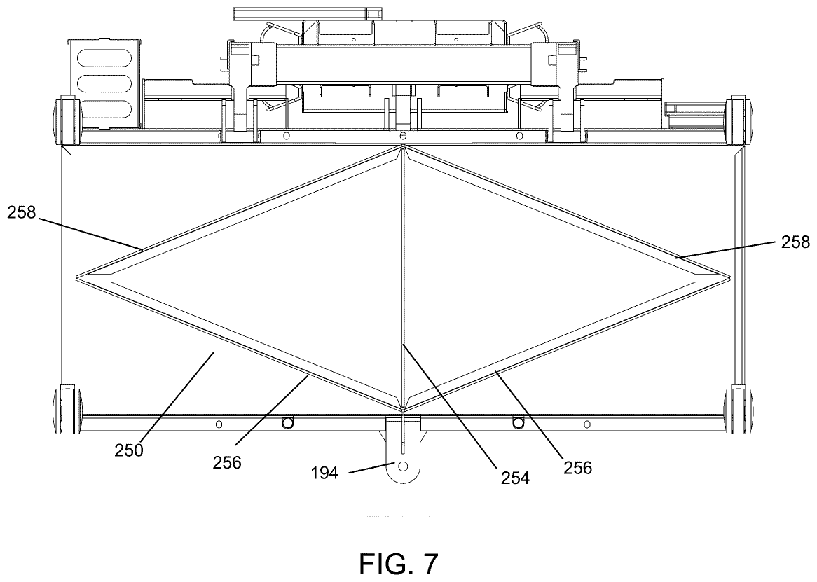

Referring to FIG. 7, the attachment assembly 100 further includes a landscaping drag assembly 250 mounted to the bottom side the base 112, providing a versatile tool for various landscaping, agricultural, and even snow plowing applications. The landscaping drag assembly 250 includes a drag stand 252 and a cross member 254. The drag stand 252 and the cross member 254 welded securely to the bottom side of the base 112, ensuring stability and durability during operation. Additionally, the landscaping drag assembly 250 includes at least one drag side panel 256 and at least one drag wear bar 258, bolted using nuts and bolts, such as carriage bolts and flange nylock lock nuts. The at least one drag side panel 256 is configured to prevent dirt or gravel from exiting from the drag stand 252. In some embodiments, multiple drag side panels 256 and drag wear bars 258 may be incorporated, each attached to the drag stand 252 to optimize performance.

In various embodiments, the landscaping drag assembly 250 is assembled in a diamond shape. This unique shape not only enhances the assembly's strength but also facilitates grading in both forward and backward directions. Furthermore, the interconnected drag side panels 256 are secured with pins, effectively preventing gravel and dirt from escaping either side of the attachment assembly 100. This design feature ensures efficient soil distribution and leveling, minimizing the need for additional passes In various embodiments, the landscaping drag assembly 250 is assembled in a diamond shape.

As previously described, material selection for the landscaping drag assembly 250 is crucial for durability and performance. While various metals can be used, steel is a common choice due to its strength and resilience. In some embodiments, components of the landscaping drag assembly 250 are constructed from the same material, preferably 7-gauge steel. This heavy-duty material ensures the landscaping drag assembly 250's ability to withstand the rigors of landscaping and agricultural tasks, providing long-lasting reliability and performance in diverse operating conditions.

Referring again to FIGS. 1 and 2, the versatility of the attachment assembly 100 is further enhanced through the addition of various attachments, expanding its functionality, and allowing users to tackle a wider range of projects with case. The attachment assembly 100 may include at least one elongated tool tube 259. In various embodiments, the attachment assembly 100 includes a plurality of tool tubes 259, for example 4. The tool tubes 259 are mounted, typically using a means for mounting such as bolts, to the back wall of the frame 110. The elongated tool tubes 259 are sized and shaped to hold equipment with long handles, including rakes, brooms, hoes, tree trimmers, pruning shears, etc. A length and a width of each tool tubes 259 is customizable by the user. In some embodiments, the tool tubes 259 may be the same length, while in other embodiments, the length and width of the tool tubes 259 are different to accommodate different sized tools and equipment. In various embodiments, the tool tubes 259 may also include at least one connection means 261, including hitch rings and hooks.

In various embodiments, the attachment assembly 100 may include a tool rack 260 mounted to the internal side 126 of the frame 110, typically using bolted connections for secure attachment. The tool rack 260 is designed to be substantially horizontal, featuring a series of holes and slots configured to accommodate agricultural tools, water bottles, or other necessary accessories. This arrangement ensures convenient storage and accessibility of essential equipment.

The tool rack 260 may incorporate additional features to maximize utility and organization. For instance, a mount rail 262 may be attached to the tool rack 260, providing a dedicated space for hanging tools or mounting storage containers. This enables users to keep their workspace tidy and well-organized, reducing clutter and minimizing the risk of misplaced equipment. Additionally, the tool rack 260 may include at least one chain saw scabbard 264, offering secure storage and transport for chain saws, ensuring safety and convenience during forestry or land-clearing operations. Overall, the inclusion of the tool rack 260 enhances the attachment assembly 100's versatility and practicality, allowing users to efficiently store and access essential tools and accessories while completing various projects.

Referring to FIG. 3, the chain saw scabbard 264 includes a scabbard bracket 265, scabbard 266 and a scabbard spacer 267 and is designed to attach to the frame 110 of the attachment assembly 100. The scabbard bracket 267, fabricated from robust materials such as 12 gauge steel, serves as the primary attachment point with the frame 110. The scabbard bracket 267 is bolted to the frame 110 using bolts and nuts for reliable and stable mounting. Additionally, the scabbard plate 266 and spacer 267 are bolted together to create an opening through which the chainsaw can be inserted and removed with ease.

In multiple embodiments, the chain saw scabbard 264 may feature variations in material composition or design to accommodate different chainsaw sizes or user preferences. For instance, alternative materials such as metal alloys or reinforced plastics may be used for the scabbard components, offering enhanced durability or weight savings depending on the intended application. Additionally, variations in the mounting method or attachment hardware may be implemented to optimize compatibility with different mounting configurations. These embodiments ensure that the chain saw scabbard meets the specific requirements and preferences of users, providing a versatile and reliable storage solution for chainsaws in various operating environments.

Referring again to FIG. 3, in some embodiments, the attachment assembly 100 is equipped with a tool box assembly 270, offering convenient storage and transportation of agricultural implements and accessories. The tool box assembly 270 may be crafted from various materials, with 12 gauge steel being a preferred choice. The tool box assembly 270 includes a tool box having a plurality of welded side walls 272 that define an opening 274 for housing agricultural implements, and other necessary accessories. The welded side walls 272 ensure structural integrity and prevent the escape of stored items during transport or operation. The tool box assembly 270 further includes a top shelf 276 that forms an open tray 278 on which additional accessories may be stored.

To secure the tool box assembly 270 to the frame 110, a mounting plate 280 is utilized and welded to the tool box 270. The mounting plate 280 serves as a reliable connection point between the tool box assembly 270 and the frame 110, ensuring stability and preventing detachment during use. To ensure the tool box assembly 270 remains securely in place during operation, bolts and nuts are employed to secure the tool box to the frame 110. Alternatively, in some embodiments, the tool box assembly 270 may be detachably attached to the frame 110 via a quick hitch tool box holder 271 that is mounted to the frame 110, allowing for easy removal and reattachment as needed. This flexibility accommodates varying user preferences and operational requirements, ensuring convenience and versatility in storage solutions.

Referring again to FIG. 3, the tool box assembly 270 may further include an additional chain saw scabbard 265 which provides a convenient and secure storage solution for chainsaws of up to approximately thirty inches in length. The chain saw scabbard 265 makes it easy to remove and insert the chainsaw. This scabbard 265 design allows users to effortlessly remove and insert the chainsaw as needed, facilitating efficient workflow during forestry or land-clearing operations. Constructed from high-quality materials, such as high-density polyethylene plastic, the scabbard ensures durability and longevity, effectively protecting the chainsaw from damage and wear.

The chain saw scabbard 265 includes a scabbard plate 267 and a scabbard spacer 269 and is designed to attach to the tool box assembly 270. The scabbard spacer 269, fabricated from robust materials such as 12 gauge steel, serves as the primary attachment point with the tool box assembly 270. The scabbard spacer 269 is bolted to the tool box assembly 270 using bolts and nuts for reliable and stable mounting. Additionally, the scabbard plate 267 and spacer 269 are welded together to create an opening through which the chainsaw can be inserted and removed with ease.

In multiple embodiments, the chain saw scabbard 265 may feature variations in material composition or design to accommodate different chainsaw sizes or user preferences. For instance, alternative materials such as metal alloys or reinforced plastics may be used for the scabbard components, offering enhanced durability or weight savings depending on the intended application. Additionally, variations in the mounting method or attachment hardware may be implemented to optimize compatibility with different tool box assemblies 270 or mounting configurations. These embodiments ensure that the chain saw scabbard 265 meets the specific requirements and preferences of users, providing a versatile and reliable storage solution for chainsaws in various operating environments.

In various embodiments, the attachment assembly 100 is equipped with a gas holder 290 designed to securely accommodate gas or oil containers on the frame 110 of the attachment assembly 100. The gas holder 290 includes a front bracket 292, upper and lower shelves 294, 296, and a back 298, all fabricated from durable 14 gauge steel. The gas holder 290 is specifically configured to define an opening that allows for the insertion of gas or oil containers, facilitating easy access and retrieval as needed. Additionally, the gas holder 290 is typically welded together for structural integrity and further reinforced by bolting it to the external side 128 of the frame 110 using bolts and nuts. This dual attachment method ensures a secure and stable mounting, preventing the gas holder from shifting or becoming dislodged during use, thereby safeguarding both the stored containers and the attachment assembly 100 itself.

In other embodiments, the gas holder 290 is designed to accommodate containers of up to approximately 1 gallon in size, providing ample storage capacity for fuel or oil supplies needed for landscaping, gardening, or agricultural operations. However, alternative embodiments may feature variations in size or capacity to accommodate larger or smaller containers, depending on the specific requirements or preferences of users. Furthermore, variations in material composition or attachment methods may be implemented to optimize durability, compatibility, or case of installation, ensuring that the gas holder meets the diverse needs of users across different applications and environments.

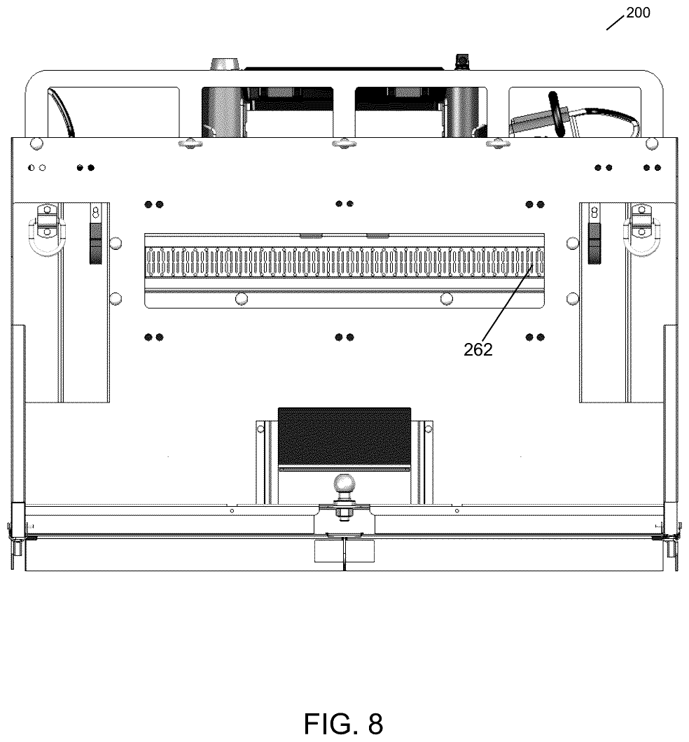

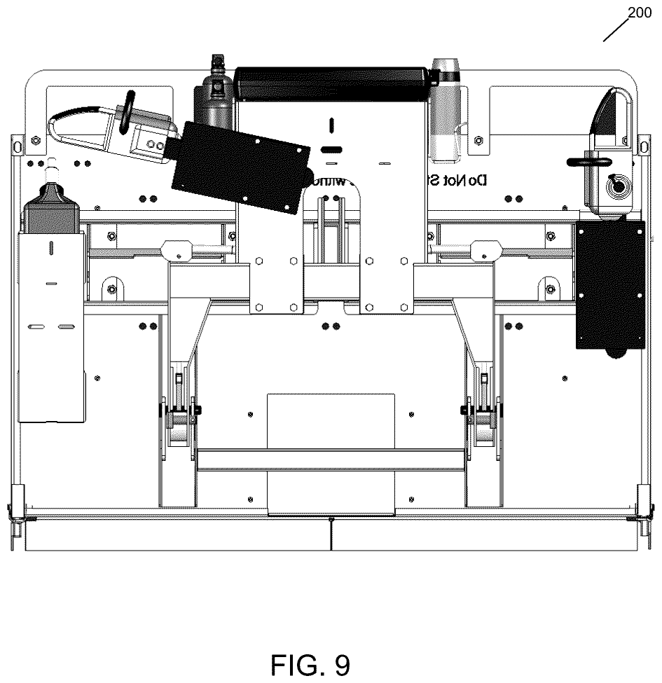

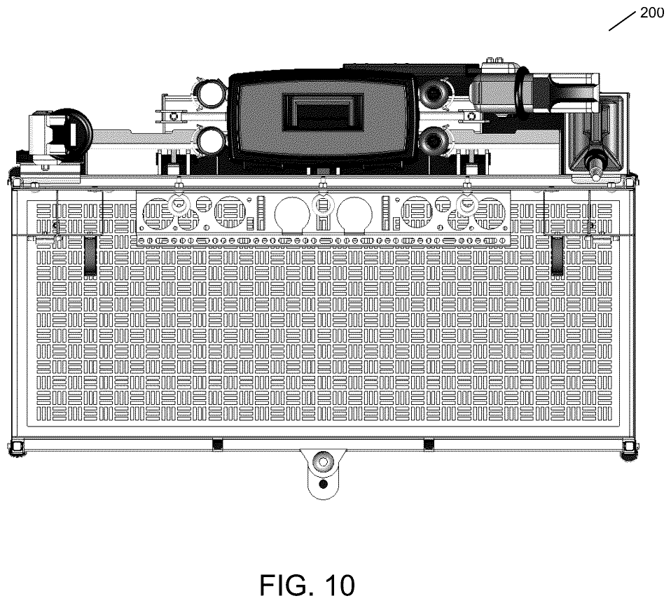

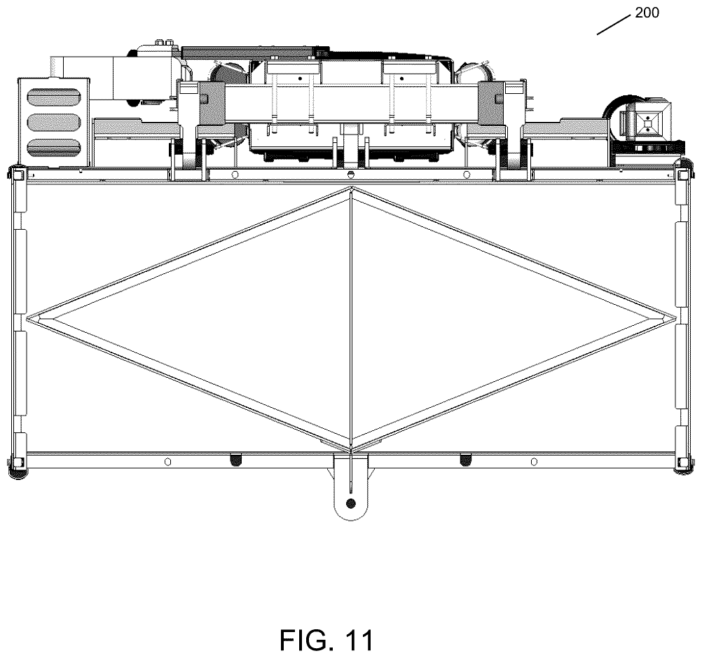

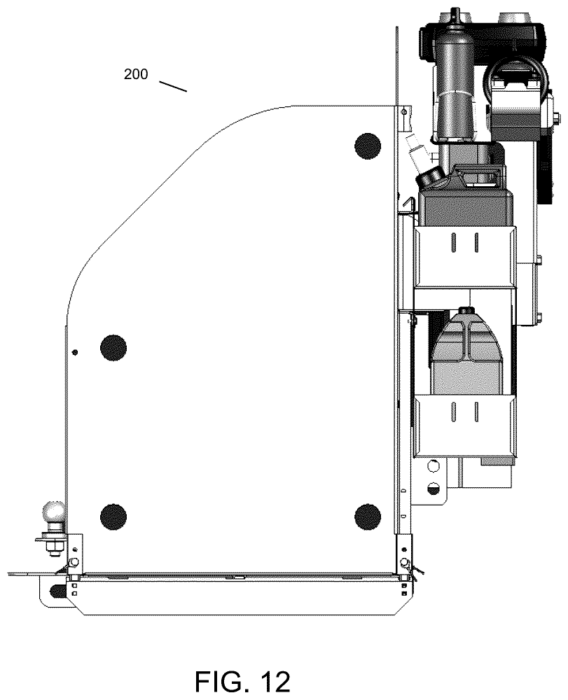

A second embodiment is illustrated in FIGS. 8-12 and is the same as the first embodiment except as described below. The attachment assembly 200 may include additional accessories for convenient use by the user. These accessories include a gas container that is configured to fit into the gas holder 290. Multiple chainsaws that are configured to be stored in the chain saw scabbards 264 and 265. The attachment assembly also includes water bottles and other personal items that are conveniently placed on the tool box assembly 270 for convenient access. The disclosure is not limited to the accessories specifically described. The attachment accessory 200 may feature other accessories not specifically described.

The present disclosure also relates to a method of transporting equipment, tools and/or people, according to some embodiments of the present disclosure. In some embodiments, the method may include providing the attachment assembly 100 as described above. Additionally, the attachment assembly 100 includes various features such as the tool rack 260 and tool box 270 integrated into the frame 110, providing convenient storage for agricultural tools and accessories. The base 112 of the attachment assembly 100 is equipped with a front bumper 180 incorporating a hitch assembly 190, allowing for detachable coupling to an agricultural vehicle.

The method may further include attaching the attachment assembly 100 to an agricultural vehicle. The method involves attaching the hitch of the attachment assembly 100 to the hitch receiver on the agricultural vehicle. This attachment secures the attachment assembly 100 to the agricultural vehicle, facilitating safe and efficient transportation of agricultural implements.

The method may further include placing agricultural implements, equipment, tools and/or people on the base 112 of the attachment assembly 100. The attachment assembly 100 accommodates various agricultural implements, tools, accessories and people, providing versatility in handling different tasks and projects.

The method may further include securing the agricultural implements to the frame 110 of the attachment assembly 100 using any securing means including but not limited to gear ties, hitch rings, the safety harness assembly. This step ensures that the implements and/or people remain stable and properly positioned during transportation, minimizing the risk of shifting, damage or injury while the attachment assembly 100 is in use.

The method may further include transporting the agricultural implements from one location to another. The attachment assembly 100 can be connected to any vehicle using the hitch assembly 190, or to a Skid Steer via the lift assembly 130. The attachment assembly 100's sturdy construction, hitch mechanism, and safety features, such as the detachable safety rail assembly 114, ensure safe and reliable transport of the agricultural implements to the desired destination.

This method allows for users to efficiently and effectively transport agricultural implements using the attachment assembly 100, benefiting from its robust design, versatile features, and secure attachment to the agricultural vehicle.

1. A multifunctional attachment assembly for attachment to a vehicle, to transport equipment, tools and/or people, the attachment assembly comprising:
a frame comprising a plurality of panels cooperating to define an open space having side walls, and a back wall;
a base having a front bumper with a hitch that couples the frame to the agricultural vehicle, wherein the base is attached to the frame and defines a floor of the attachment assembly;
a safety rail assembly detachably attached to the frame; and
a leveling drag mounted on a bottom side of the base.

2. The attachment assembly of claim 1, wherein the attachment assembly further comprises a removable tool box attached to the back wall of the frame.

3. The attachment assembly of claim 2, wherein the tool box includes a chainsaw scabbard that is configured to receive a chainsaw.

4. The attachment assembly of claim 1, wherein the frame further includes a plurality of handles integrated into a top end of the frame.

5. The attachment assembly of claim 1, having a tool rack mounted to the front of the frame between the side walls.

6. The attachment assembly of claim 1, wherein the attachment assembly further includes a plurality of elongated tool tubes mounted to the frame.

7. The attachment assembly of claim 1, wherein the base further includes a plurality of wheels detachably attached to the base though at least one wheel tube.

8. The attachment assembly of claim 1, wherein the base supports the transport of the equipment, tools, and at least one person.

9. The attachment assembly of claim 1, wherein the safety rail assembly includes a safety railing door latched to the frame and configured to open to about 180 degrees.

10. The attachment assembly of claim 1, wherein the attachment assembly further comprises a safety harness that is configured to secure the equipment, the tools, and
the at least one person to the within the attachment assembly.

11. The attachment assembly of claim 1, wherein the leveling drag is a diamond shaped landscaping drag.

12. The attachment assembly of claim 11, wherein the leveling drag includes at least one side panel to prevent dirt or gravel from exiting from the drag.

13. The attachment assembly of claim 1, the attachment assembly further comprises a lift assembly having a plurality of brackets mounted to the frame.

14. The attachment assembly of claim 1, wherein the hitch is an integrated 3-way universal hitch.

15. An attachment assembly for attachment to a vehicle to transport agricultural equipment, tools and at least one person, the attachment assembly comprising:
a frame comprising plurality of panels cooperating to define an open space having side walls, and a back;
a base having a front bumper with a hitch that detachably couples the frame to the agricultural vehicle, wherein the base is attached to the frame and defines a floor of the attachment assembly;
a safety rail assembly detachably attached to a front end of the frame;
a leveling drag mounted on a bottom side of the base;
a toolbox mounted to the back of the frame and having a plurality of side walls that define an opening for housing agricultural equipment; and
a lift assembly attached to the frame and configured to attach to the agricultural vehicle and allow the attachment assembly to be lifted in the air.

16. The attachment assembly of claim 15, wherein the frame further includes a plurality of handles integrated into a top end of the frame.

17. The attachment assembly of claim 15, wherein the base further includes a plurality of wheels detachably attached to the base though at least one wheel tube.

18. The attachment assembly of claim 17, wherein the base supports the agricultural implements, tools, and at least one person.

19. The attachment assembly of claim 15, wherein the leveling drag is a diamond shaped landscaping blade.

20. A method of transporting agricultural implements using a attachment assembly, the method comprising the steps:
providing a attachment assembly comprising
a frame comprising plurality of panels cooperating to define an open space having side walls, and a back, wherein the frame includes a tool rack
a base having a front bumper with a hitch that detachably couples the frame to the agricultural vehicle, wherein the base is attached to the frame and defines a floor of the attachment assembly, and
a safety rail assembly detachably attached to a front end of the frame,
attaching the hitch of the attachment assembly to an agricultural vehicle;
placing agricultural equipment on the base of the attachment assembly;
securing the agricultural equipment to the frame of the attachment assembly; and
transporting the agricultural equipment from one location to another.
